(19) United States
(12) Patent Application Publication
(10) Pub. No.: US 2025/0027219 A1
(43) Pub. Date: Jan. 23, 2025

(54) DOUBLE PEROVSKITE MATERIAL AND PREPARATION METHOD THEREOF, AND REVERSIBLE PROTONIC CERAMIC ELECTROCHEMICAL CELL

(71) Applicants: Zijin Mining Renewable Energy and Advanced Materials (Changsha) Co., Ltd., Changsha City (CN); South China University of Technology, Guangzhou City (CN)

(72) Inventors: Ying LIU, Changsha City (CN); Yu Chen, Changsha City (CN); Yangsen Xu, Guangzhou City (CN)

(21) Appl. No.: 18/760,020

(22) Filed: Jul. 1, 2024

(30) Foreign Application Priority Data
Jul. 21, 2023 (CN) 2023109027140

(51) Int. Cl. C25B 11/077; C01G 51/00; C25B 9/23; C25B 11/067; C25B 13/07; H01M 4/86; H01M 4/88; H01M 4/90; H01M 8/12; H01M 8/1253; H01M 8/126

(52) U.S. Cl. CPC C25B 11/0773; C01G 51/70; C25B 9/23; C25B 11/067; C25B 13/07; H01M 4/8803; H01M 4/9033; H01M 8/1253; H01M 8/126; C01P 2002/34; C01P 2002/50; C01P 2002/72; C01P 2002/76; C01P 2002/82; C01P 2002/85; C01P 2006/40; H01M 2004/8689; H01M 2008/1293

(57) ABSTRACT

The present application relates to the field of a reversible protonic ceramic electrochemical cell, specifically, to a double perovskite material and preparation method thereof, and a reversible protonic ceramic electrochemical cell. The expression for the double perovskite material is PrBa_{0.9}Cs_{0.1}Co₂O_{6-δ}, wherein δ is oxygen vacancy content. The present application also provides a preparation method for the double perovskite material and a reversible protonic ceramic electrochemical cell comprising the double perovskite material. The Cs⁺ doped double perovskite material provided by the present application has good stability, lower polarization impedance, and higher ORR/OER activity. The reversible protonic ceramic electrochemical cell provided by the present application has good stability, electrocatalytic activity, and electrochemical performance.

### CROSS-REFERENCE TO RELATED APPLICATION

The present application claims priority to Chinese Patent Application No. 202310902714.0, entitled “double perovskite material and preparation method thereof, and reversible protonic ceramic electrochemical cell”, and filed on Jul. 21, 2023, the entire disclosure of which is incorporated herein by reference in its entirety.

### TECHNICAL FIELD

The present application relates to the field of a reversible protonic ceramic electrochemical cell, specifically, to a double perovskite material and preparation method thereof, and a reversible protonic ceramic electrochemical cell.

### BACKGROUND ART

Due to the limited storage of fossil fuels and the increasing greenhouse gas emissions, there is an urgent need to find a clean and pollution-free energy conversion device to alleviate the current energy and environmental crisis. The reversible protonic ceramic electrochemical cell (R-PCEC) technology can be one of the effective means to solve current problems. When the reversible protonic ceramic electrochemical cell operates in fuel cell mode, the chemical energy can be converted into electrical energy; and when the reversible protonic ceramic electrochemical cell operates in electrolysis mode, the electrical energy can be converted into chemical energy. In addition, R-PCEC based on proton conductor electrolyte has high proton conductivity, and can be operated at medium and low temperatures (400° C. to 700° C.). The lower working temperature of R-PCEC is not only beneficial for extending the lifespan of the cell itself, but also for reducing production costs. However, as the working temperature of R-PCEC decreases, the reaction kinetics of the air electrode becomes sluggish, and thereby significantly reducing the electrochemical performance of R-PCEC. Therefore, designing an air electrode material with high catalytic activity for oxygen reduction reaction (ORR)/oxygen evolution reaction (OER) and sufficient chemical stability under the operating conditions of medium and low temperatures is one of the most significant challenges faced by R-PCEC.

In recent years, researchers have designed many air electrode materials, but most of them exhibit moderate electrochemical performance in R-PCEC. Double perovskite material PrBaCo₂O_{6-δ} (PBC) has excellent electronic conductivity, oxygen ion conductivity, excellent oxygen surface exchange coefficient, and oxygen ion diffusion kinetics, and exhibits excellent electrochemical performance when used as an air electrode in solid oxide fuel cells (SOFCs). As the doping of Cs can improve the thermal stability and moisture resistance of the material's crystal structure, cesium (Cs) has been used in the design of perovskite solar cell materials. Density functional theory (DFT) calculations indicate that the increase in ORR activity of the air electrode after doping Cs is mainly due to the electron pair shift caused by the polarization distribution of Lewis acidity intensity at the A and B sites, thereby reducing the oxygen vacancy formation energy of the oxide. There are currently few reports on the application of air electrodes designed by doping A-site Cs in R-PCEC.

### SUMMARY

In order to solve the above-mentioned technical problems, the present application provides a double perovskite material and preparation method thereof, as well as a reversible protonic ceramic electrochemical cell. The double perovskite material (doped with low Lewis acid strength cationic Cs⁺) provided by the present application has better electrochemical stability, lower polarization impedance, and higher ORR/OER activity. The present application also provides a preparation method for the above-mentioned double perovskite material doped with low Lewis acid strength cationic Cs⁺. Based on the double perovskite material, the present application also provides a reversible protonic ceramic electrochemical cell, which exhibits excellent electrochemical performance and good stability.

Specifically, in the first aspect, the double perovskite material provided by the present application is expressed as PrBa₁₋ₓCsₓCo₂O_{6-δ}; wherein δ is oxygen vacancy content.

According to the present application, it is beneficial for improving the hydration ability of perovskite oxides when doping with A-site dopants with lower acidity. In addition, when Cs is used as an A-site cation dopant in the air electrode of a fuel cell, the kinetics of the redox reaction of the air electrode is closely related to the Lewis acid strength of the doped ions. When Cs⁺ is used as an A-site dopant, the polarization distribution of Lewis acid strength between A-site and B-site ions leads to electron pair shift, increasing the oxygen vacancy content in the oxide, which is beneficial for improving the oxygen exchange kinetics on the electrode surface and accelerating the redox reaction process. Therefore, the doping of Cs⁺ can effectively enhance the catalytic activity of the air electrode, thereby improving the electrochemical performance of R-PCEC at medium and low temperatures, partially replacing Ba²⁺ in the double perovskite oxide PBC with low Lewis acid strength cationic Cs⁺.

Furthermore, the present application designs and prepares a new double perovskite material PrBa₁₋ₓCsₓCo₂O_{6-δ} (PBCsC) as an air electrode for R-PCEC to evaluate its electrocatalytic activity and water splitting ability at medium and low temperatures. It has important practical significance for designing and implementing an air electrode with high catalytic activity and stability, and applying the air electrode to R-PCEC.

Preferably, x is in a range from 0.01 to 0.15.

Further preferably, x is in a range from 0.05 to 0.125.

Preferably, the double perovskite material has a tetragonal layered perovskite structure. The double perovskite material has a perovskite structure doped with Cs at the A-site. In the present application, the ion radius of Cs is 167 pm, and the ion radius of Ba is 135 pm. The ion radius of Ba is closest to that of Cs (the ion radius of Pr³⁺ and Pr⁴⁺ are 99 pm and 85 pm; and the ion radius of Co²⁺, Co³⁺, and Co⁴⁺ are 74.5 pm, 61 pm, and 53 pm), and Cs⁺ replaces the Ba ions in the structure.

Further preferably, the lattice parameters are as follows: 3.9045±0.1 Å for a, 3.9045±0.1 Å for b, and 7.6572±0.1 Å for c.

Further preferably, the expression of the double perovskite material is PrBa_{0.9}Cs_{0.1}Co₂O_{6-δ}, wherein 0.1≤δ≤0.3.

According to the present application, further experimental research has found that the PBCsC with the above-mentioned x value has excellent electrocatalytic performance, especially when the preferred x=0.1 is used for partial substitution of Ba, which can unexpectedly make the reversible protonic ceramic electrochemical cell have better electrochemical performance and stability than other values.

In the second aspect, the present application provides a preparation method of the double perovskite material, wherein the method comprises the following steps:
1) dissolving praseodymium nitrate, barium nitrate, cesium nitrate, and cobalt nitrate in water to obtain a mixed liquid; then mixing the mixed liquid, ethylenediaminetetraacetic acid, citric acid, and ammonia water, adjusting pH to 7 to 8, and obtaining a mixed solution; and
2) heating the mixed solution until gelatinous, subjecting the resultant to a high temperature treatment at 200° C. to 250° C. to obtain a precursor, and calcining the precursor.

Preferably, in step 1), the molar ratio of metal elements, ethylenediaminetetraacetic acid, and citric acid is (0.5 to 1.5):(0.5 to 1.5):(1 to 2), preferably 1:1:1.5; wherein the amount for the metal elements is the sum of Pr, Ba, Cs, and Co. It has been found through experimental research that the present application can significantly improve phase formation effect (crystallization strength) of PrBa_{0.9}Cs_{0.1}Co₂O_{6-δ} by using a specific proportion of metal elements, ethylenediaminetetraacetic acid and citric acid combined with the preferred sintering temperature of the present application, such that PrBa_{0.9}Cs_{0.1}Co₂O_{6-δ} can exhibit superior crystal structure.

Preferably, in step 2), the mixed solution is heated at a temperature of 80° C. to 100° C.

Preferably, the high-temperature treatment is performed for 2 to 6 hours, preferably 2 hours.

Preferably, in step 2), the precursor is calcined at a temperature of 950° C. to 1050° C., preferably 1000° C.; and the precursor is calcined for 2 to 4 hours, preferably 2 hours.

In the present application, the combination of the raw materials used and the preferred preparation conditions can improve the phase formation effect, which is conducive to the preparation of PrBa_{0.9}Cs_{0.1}Co₂O_{6-δ} with better crystallization strength and crystal structure.

The further prepared reversible protonic ceramic electrochemical cell can exhibit comprehensive performance in terms of superior electrochemical performance and stability and other aspects.

In the third aspect, the present application also provides the use of the double perovskite material, and the double perovskite material is used as an air electrode in a reversible protonic ceramic electrochemical cell.

In the fourth aspect, the present application also provides a reversible anode supported protonic ceramic electrochemical cell, and the reversible protonic ceramic electrochemical cell comprises an anode support layer, an electrolyte, and an air electrode connected in sequence.

The air electrode is prepared from the double perovskite material doped with low Lewis acid strength cationic Cs⁺ as described above.

Preferably, the electrolyte material comprises BaZr_{0.1}Ce_{0.7}Y_{0.1}Yb_{0.1}O_{3-δ} (BZCYYb1711), wherein δ is oxygen vacancy content (0≤δ≤0.2).

Preferably, the material of the anode support layer comprises NiO and BaZr_{0.1}Ce_{0.7}Y_{0.1}Yb_{0.1}O_{3-δ}, wherein the mass ratio of NiO and BaZr_{0.1}Ce_{0.7}Y_{0.1}Yb_{0.1}O_{3-δ} is (5.5 to 6.5):(3.5 to 4.5), preferably 6:4, δ is oxygen vacancy content.

Preferably, the reversible protonic ceramic electrochemical cell further comprises a transition layer, wherein the transition layer is disposed between the anode support layer and the electrolyte; preferably, the transition layer comprises NiO and BaZr_{0.1}Ce_{0.7}Y_{0.1}Yb_{0.1}O_{3-δ} (BZCYYb1711); wherein the mass ratio of NiO and BaZr_{0.1}Ce_{0.7}Y_{0.1}Yb_{0.1}O_{3-δ} is (5.5 to 6.5):(3.5 to 4.5), preferably 6:4, δ is oxygen vacancy content.

According to the present application, the term δ used in each layer of the reversible protonic ceramic electrochemical cell all refers to the oxygen vacancy content. If the scope of δ is not limited by the present application, it means that the conventional range of oxygen vacancy content in the art can be used, such as 0 to 0.5, 0.1 to 0.4, or 0.1 to 0.2.

In the present application, the anode supported protonic ceramic electrochemical cell adopts a co-casting method, and the electrolyte layer, the transition layer and the anode layer are tightly connected to each other without any separation between layers. This can significantly improve the stability of the half-cell structure and reduce the contact resistances between the layers of the half-cell, and enable the anode supported protonic ceramic electrochemical cell to exhibit better electrochemical performance.

Further preferably, the preparation method of the reversible anode supported protonic ceramic electrochemical cell comprises the following steps:
1) materials of the anode support layer, transition layer, electrolyte, and air electrode are prepared into slurries, respectively;
2) the electrolyte slurry, transition layer slurry, and anode support layer slurry are sequentially casted on the tape casting machine, and then naturally dried for 10 to 14 hours, and the co-casted thin sheets after natural drying are subjected to debinding treatment and high-temperature sintering to obtain an anode supported half-cell; preferably, the debinding treatment is performed at 500° C. to 700° C. for 1 to 3 hours; and the high-temperature sintering is performed at 1400° C. to 1500° C. for 4 to 6 hours; and
3) the materials of the air electrode are prepared into a slurry, and the slurry is brushed onto the surface of electrolyte of the half-cell, the resultant is subjected to high-temperature sintering to obtain a reversible anode supported protonic ceramic electrochemical full cell; preferably, the high-temperature sintering is performed at 800° C. to 1000° C. for 1 to 3 hours.

Further preferably, the substrate is a polymer thin film.

Further preferably, the electrolyte layer slurry is obtained by ball milling BZCYYb1711 powder, dispersant, and anhydrous ethanol.

Further preferably, the transition layer slurry is obtained by blending BZCYYb1711 powder, nano-size nickel oxide, graphite, dispersant, anhydrous ethanol and butyl acetate, and ball milling for 12 hours.

Further preferably, the anode support layer slurry is obtained by blending BZCYYb1711, nickel oxide, graphite, dispersant, anhydrous ethanol, and butyl acetate, and ball milling for 10 to 14 hours.

Further preferably, the air electrode slurry is obtained by blending the PrBa_{0.9}Cs_{0.1}Co₂O_{6-δ} material with terpineol; and the slurry is composed of 1 g:(0.5 to 0.7 g) of PrBa_{0.9}Cs_{0.1}Co₂O_{6-δ} and terpineol.

Further preferably, in the anode supported half-cell, a thickness of the electrolyte layer is 7 to 9 μm, a thickness of the anode support layer is 600 to 700 μm, and a thickness of the transition layer is 16 to 22 μm.

In the present application, it has been found through experimental research that when using the above optimized parameters of sintering temperature and time for the preparation of the anode supported half-cell, adjusting the thickness of the anode support layer can improve the mechanical strength of the half-cell and make the anode supported half-cell exhibit better structural stability.

The beneficial effects of the present application at least lie in the follows: the double perovskite material doped with low Lewis acid strength cationic Cs⁺ of the present application is obtained by element doping at A site on the basis of a double perovskite material PrBaCo₂O_{6-δ}. Air electrode material PrBa_{0.9}Cs_{0.1}Co₂O_{6-δ} (PBCsC) for the anode supported reversible protonic ceramic electrochemical cell is prepared by sol-gel method. The air electrode material for the anode supported reversible protonic ceramic electrochemical cell of the present application has lower polarization impedance and higher electrocatalytic activity. The polarization resistances of the anode supported single cell NiO-BZCYYb1711∥transition layer NiO-BZCYYb1711∥BZCYYb1711∥PBCsC prepared by the present application at 650° C., 600° C., 550° C., and 500° C. are 0.045Ω cm², 0.094Ω cm², 0.273Ω cm² and 1.037Ω cm², respectively, the maximum power densities are 1.66 W cm⁻², 1.19 W cm⁻², 0.72 W cm⁻², and 0.41 W cm⁻², respectively. When humidified air is introduced to the air electrode side, R-PCEC operates in electrolysis mode with current densities of −2.85 A cm⁻², −1.48 A cm⁻², −0.71 A cm⁻², and −0.31 A cm⁻² under voltage condition of 1.3 V at 650° C., 600° C., 550° C., and 500° C., respectively. The anode supported reversible protonic ceramic electrochemical cell of the present application has excellent stability, oxygen ion exchange kinetics, electrocatalytic activity, and electrochemical performance.

### BRIEF DESCRIPTION OF THE DRAWINGS

In order to provide a clearer explanation of the examples of the present application and the technical solutions in the prior art, a brief introduction will be given below to the accompanying drawings required in the examples or prior art descriptions. It is evident that the drawings in the following description are some examples of the present application. For a person skilled in the art, other drawings can be obtained based on these drawings without creative labor.

FIG. 1 shows a refined XRD spectrum of air electrode material PrBa_{0.9}Cs_{0.1}Co₂O_{6-δ} (PBCsC) involved in Example 1 of the present application after calcining at 1000° C. for 2 hours;

FIG. 2 shows an XRD spectrum of air electrode material PrBa_{0.9}Cs_{0.1}Co₂O_{6-δ} (PBCsC) involved in Example 1 of the present application and electrolyte BZCYYb powder after co-firing at 950° C. for 2 hours in a high-temperature muffle furnace;

FIG. 3 shows an XRD spectrum of air electrode material PrBa_{0.9}Cs_{0.1}Co₂O_{6-δ} (PBCsC) involved in Example 1 of the present application after 10 hours of treatment with 30% water at 600° C.;

FIG. 4 shows a high-temperature in-situ XRD spectrum of air electrode material PrBa_{0.9}Cs_{0.1}Co₂O_{6-δ} (PBCsC) involved in Example 1 of the present application after calcining at 1000° C. for 2 hours;

FIG. 5 shows the X-ray photoelectron spectra (XPS) of the air electrode materials PBCsC and PBC involved in Example 1 of the present application, wherein a is Pr 3d, and b is Co 2p;

FIG. 6 shows the O1s X-ray photoelectron spectra of the air electrode materials PBCsC (6a) and PBC (6b) involved in Example 1 of the present application;

FIG. 7 shows the relaxation characterization diagram of the air electrode materials PBCsC and PBC involved in Example 1 of the present application;

FIG. 8 shows the area specific impedance diagram (8a) and impedance stability diagram (8b) of the symmetric cell involved in Example 1 of the present application with PBCsC as the electrode and BZCYYb1711 as the electrolyte support body in humidified air (3% H₂O);

FIG. 9 shows the electrochemical stability of the symmetric cell involved in Example 1 of the present application with PBCsC and PBC as the electrode and BZCYYb1711 as the electrolyte support body in humidified air (3% H₂O);

FIG. 10 shows the infrared spectra of PBCsC and PBC oxide involved in Example 1 of the present application after being treated at 600° C. in air containing 30% water vapor for 50 hours;

FIG. 11 shows the peak power density diagram of a single cell (Ni-BZCYYb1711∥transition layer Ni-BZCYYb1711∥BZCYYb1711∥PBCsC) prepared with PBCsC as the air electrode and Ni BZCYYb1711 as the fuel electrode support involved in Example 2 of the present application at 650° C. to 500° C. in FC mode (with humidified hydrogen gas on the anode side, and ambient air on the oxygen electrode side);

FIG. 12 shows the current density diagram corresponding to 1.3 V of a single cell (Ni-BZCYYb1711∥transition layer Ni-BZCYYb1711∥BZCYYb1711∥PBCsC) prepared with PBCsC as the air electrode and Ni BZCYYb1711 as the fuel electrode support involved in Example 2 of the present application when tested at 650° C. to 500° C. in EC mode (with humidified hydrogen gas on the anode side, and humidified air on the oxygen electrode side);

FIG. 13 shows the operational stability diagram of a single cell (Ni-BZCYYb1711∥transition layer Ni-BZCYYb1711∥BZCYYb1711∥PBCsC) prepared with PBCsC as the air electrode and Ni-BZCYYb1711 as the anode support involved in Example 2 of the present application when tested at 650° C. in single cell fuel cell mode and in electrolytic cell mode;

FIG. 14 shows the cyclic stability diagram of a single cell (Ni-BZCYYb 1711∥transition layer Ni-BZCYYb1711∥BZCYYb1711∥PBCsC) prepared with PBCsC as the air electrode and Ni BZCYYb1711 as the fuel electrode support involved in Example 2 of the present application when tested at 600° C.;

FIG. 15 shows the variation diagram of Faradaic efficiency with applied current density of a single cell (Ni-BZCYYb 1711∥transition layer Ni-BZCYYb1711∥BZCYYb1711∥PBCsC) prepared with PBCsC as air electrode and Ni BZCYYb1711 as anode support layer involved in Example 2 of the present application; and

FIG. 16 shows the variation diagram of hydrogen production rate with applied current density of a single cell (Ni-BZCYYb1711∥ Transition Ni-BZCYYb1711∥BZCYYb1711∥PBCsC) prepared with PBCsC as air electrode and Ni BZCYYb 1711 as anode support layer involved in Example 2 of the present application.

### SPECIFIC MODES FOR CARRYING OUT THE EMBODIMENTS

In order to make the purpose, technical solutions, and advantages of the examples of the present application clearer, the technical solutions in the examples of the present application are described clearly and completely as follows. Obviously, the described examples are a part of the examples of the present application, rather than the entire examples. Based on the examples in the present application, all other examples obtained by a person skilled in the art without creative labor fall within the scope of protection of the present application.

Unless otherwise specified, the raw materials and reagents used in the following examples are commercially available or can be prepared by known methods. If specific techniques or conditions are not specified in the examples, they are all carried out using conventional methods or according to the techniques or conditions described in the literature in the art, or according to the product manual. The reagents and instruments used without indication of manufacturers, are conventional products that can be purchased through legitimate channels.

The present application is further explained in conjunction with examples as follows.

The examples of the present application relate to the preparation and characterization of an air electrode material doped with low Lewis acid strength cationic Cs⁺. The molecular formula of the air electrode material is PrBa_{0.9}Cs_{0.1}Co₂O_{6-δ} (PBCsC). The oxygen reduction/evolution reaction activity and stability of the anode supported reversible protonic ceramic electrochemical cell are improved by doping of Cs ions on A site of perovskite material PrBaCo₂O_{6-δ}. The catalytic activity and stability of PrBa_{0.9}Cs_{0.1}Co₂O_{6-δ} (PBCsC) air electrode are improved by doping of Cs⁺ at A site. At 650° C., the single cell composed of Ni-BZCYYb1711| transition layer Ni-BZCYYb1711|BZCYYb1711|PBCsC has a maximum output power of 1.66 W cm⁻² in FC mode, and the polarization resistance of the cell is only 0.045Ω cm². After introducing air containing 3% water vapor on the air electrode side, a current density of −2.85 A cm⁻² was obtained under conditions of 650° C. and voltage of 1.3 V. In the present application, the polarization impedance of PrBaCo₂O_{6-δ} air electrode can be significantly reduced and the electrochemical performance of the full cell can be improved by doping of low Lewis acid strength cationic Cs⁺. In electrolysis mode, the current density can also be significantly increased and excellent stability is exhibited.

In addition, there is currently relatively little research on the cycling stability of the anode supported reversible protonic ceramic electrochemical cell at medium and low temperatures, and there are extremely few characterization methods for the stability of the reversible protonic ceramic electrochemical cell. In order to characterize the cycling stability of the reversible protonic ceramic electrochemical cell involved in the present application, an example of the present application also provides a testing method. The main steps are as follows: the air electrode material is brushed onto the electrolyte membrane of the anode supported protonic conductor single cell, hydrogen gas containing 3% water vapor is introduced to the anode side, and air containing 3% water vapor is introduced to the air electrode side. Cyclic stability testing is conducted on a single cell, that is, the anode supported reversible protonic ceramic electrochemical cell is alternately cycled between fuel cell mode and electrolysis cell mode by applying a current of ±0.5 A cm⁻², so as to evaluate the electrochemical stability of the air electrode.

In the following examples, the composition of the baseline sample is PrBaCo₂O_{6-δ}, and the preparation process thereof is the same as that in the example.

### Example 1

The present Example provides a method for preparing the air electrode material PrBa_{0.9}Cs_{0.1}Co₂O_{6-δ} of an anode supported reversible protonic ceramic electrochemical cell. The specific steps are as follows:
1) according to the stoichiometric ratio of PrBa_{0.9}Cs_{0.1}Co₂O_{6-δ} (PBCsC), praseodymium nitrate, barium nitrate, cesium nitrate and cobalt nitrate were sequentially added to a deionized water solution; subsequently, citric acid was added at 1.5 times of the molar amount of metal ions, and ethylenediamine tetraacetic acid was added at 1 time of the molar amount of metal ions; wherein, praseodymium nitrate, barium nitrate, cesium nitrate, cobalt nitrate, citric acid and ethylenediamine tetraacetic acid were purchased from Aladdin Chemical Reagent Network;
2) a complexing agent was added to the solution dissolved with metal ions, ammonia water was added, and the pH value was adjusted to 7 to 8, and then the mixture was heated and stirred under the condition of magnetic stirring until most water was evaporated to obtain a gelatinous substance;
3) the gelatinous substance was dried in an air drying oven and at 250° C. for 2 hours to obtain a fluffy porous precursor; and
4) the precursor was placed in a high-temperature muffle furnace and calcined at 1000° C. for 2 hours to obtain the required air electrode material powder, PrBa_{0.9}Cs_{0.1}Co₂O_{6-δ} (denoted as PBCsC), wherein 0.1≤δ≤0.3.

### Example 2

The present Example provides a fabrication procedure of a reversible anode supported protonic ceramic electrochemical cell of Ni-BZCYYb1711|transition layer Ni-BZCYYb1711|BZCYYb1711|PBCsC prepared with PrBa_{0.9}Cs_{0.1}Co₂O_{6-δ} (PBCsC) provided in Example 1 as the air electrode. The specific steps are as follows:
(1) preparation of electrolyte layer slurry: 3 g of BZCYYb1711 powder, 0.1 g of fish oil dispersant, 0.8 g of anhydrous ethanol, and 0.8 g of butyl acetate were uniformly mixed to obtain BZCYYb1711 electrolyte layer slurry; preparation of transition layer slurry: 1.2 g of BZCYYb1711 powder, 1.8 g of nano-size nickel oxide, 0.3 g of graphite, 0.1 g of fish oil dispersant, 0.75 g of anhydrous ethanol, and 0.75 g of butyl acetate were uniformly mixed to obtain Ni BZCYYb1711 transition layer slurry; preparation of anode support layer slurry: 10 g of BZCYYb1711, 15 g of nickel oxide, 1.5 g of graphite, 1 g of fish oil dispersant, 3 g of anhydrous ethanol, and 3 g of butyl acetate were uniformly mixed to obtain an anode slurry; and the above-mentioned slurries were separately ball milled for 30 to 40 hours;
(2) the electrolyte slurry, transition layer slurry, and anode slurry after ball milling were sequentially cast onto a thin PET (polyethylene terephthalate) release film, then, the electrolyte layer-transition layer-anode support layer tape after co-casting was natural dried in air for 12 hours, and then, the resulting green tape was punched into 15 mm diameter samples, and the samples were debound in a muffle furnace at 600° C. for 2 hours of; finally, the samples were placed in a high-temperature muffle furnace and sintered at 1450° C. for 5 hours to obtain the required anode supported half-cell; wherein the prepared anode supported half-cell includes a BZCYYb1711 electrolyte layer (with a thickness of 7 to 9 μm), a Ni BZCYYb1711 transition layer (with a thickness of 30 μm), and a Ni BZCYYb1711 anode support layer (with a thickness of 600 to 700 μm);
(3) 1 g of the air electrode powder PrBa_{0.9}Cs_{0.1}Co₂O_{6-δ} prepared in Example 1 was weighed and uniformly mixed with 0.6 g of terpineol to obtain the required air electrode slurry; and
(4) the prepared air electrode slurry was brushed onto the electrolyte membrane of the half-cell, then placed in a 70° C. oven, after the cathode slurry was dried, the assembled full cell was calcined at 950° C. in a high-temperature muffle furnace for 2 hours before electrochemical performance testing in FC and EC modes.

### Characterization Results

### 1. XRD Characterization

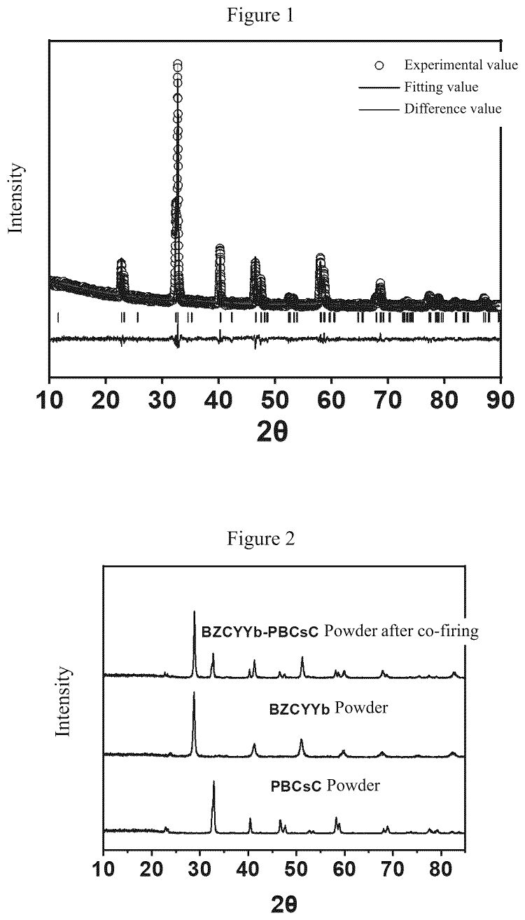

FIG. 1 shows a refined XRD spectrum of PrBa_{0.9}Cs_{0.1}Co₂O_{6-δ} (PBCsC) after calcining at 1000° C. for 2 hours; it shows that the synthesized PBCsC exhibits a single double perovskite phase structure. Meanwhile, the XRD refinement results show that the synthesized PBCsC has a tetragonal layered perovskite structure, with lattice parameters of a=b=3.9045 Å and c=7.6572 Å (refinement parameter: GOF=2.13).

FIG. 2 shows the chemical compatibility between the synthesized air electrode material PBCsC and the electrolyte BZCYYb1711 powder. From the figure, it can be seen that there is no chemical reactions between PBCsC and BZCYYb1711 after calcined at 950° C. for 2 hours in a high-temperature muffle furnace, indicating that PBCsC material has good chemical compatibility with BZCYYb1711 powder.

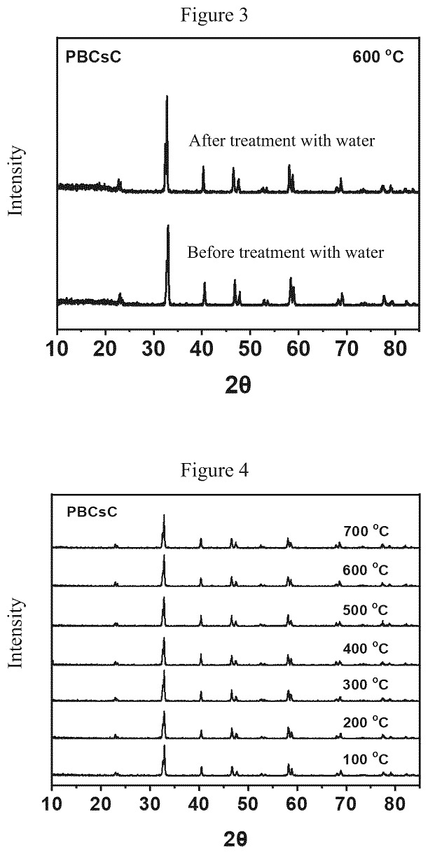

FIG. 3 shows an XRD spectrum of PrBa_{0.9}Cs_{0.1}Co₂O_{6-δ} (PBCsC) after 10 hours of treatment with air containing 30% water vapor at 600° C. for 10 hours; wherein the main peak of the XRD spectrum of the treated PBCsC shifted significantly towards a lower angle, possibly due to the expansion of the lattice caused by water vapor entering the lattice.

FIG. 4 shows a high temperature in-situ XRD spectrum of PrBa_{0.9}Cs_{0.1}Co₂O_{6-δ} (PBCsC) powder. It can be seen from the spectrum that no impure phase is generated in PBCsC powder during the continuous heating test from 100° C. to 700° C. (holding time at each temperature is 1 hour), indicating that PBCsC oxide exhibits good phase structure stability and chemical stability at high temperatures. In the high-temperature in-situ XRD testing of PBCsC oxides, as the testing temperature increases, the main peak of PBCsC shifts towards a lower angle, which can be attributed to the lattice expansion caused by the increase in temperature.

### 2. X-Ray Photoelectron Spectroscopy (XPS) Characterization

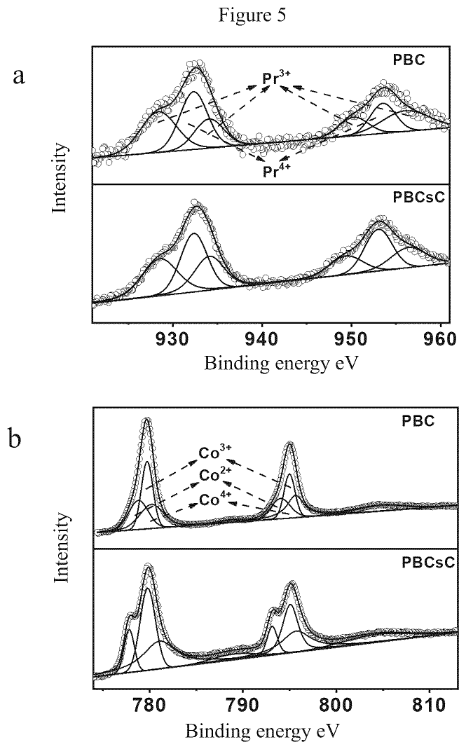

According to the fitting data, after Cs partially replaces the Ba element at A-site in PBC, the high valence state proportions of Pr (FIG. 5(a)) and Co (FIG. 5(b)) were further increased in order to maintain their own electrical neutrality. As shown in FIG. 5(a), the content of Pr⁴⁺ in PBC is 37.9%, while the content of Pr⁴⁺ in PBCsC increases to 41.1%. The Co element also showed a similar trend of change, as shown in FIG. 5(b). In PBC, the contents of Co³⁺ and Co⁴⁺ were 36.7% and 35.0%, respectively, while in PBCsC, these contents increased to 41.8% and 43.5%, respectively. The XPS results indicate that the doping of Cs into PBC leads to an increase in the high valence cation content of Pr and Co.

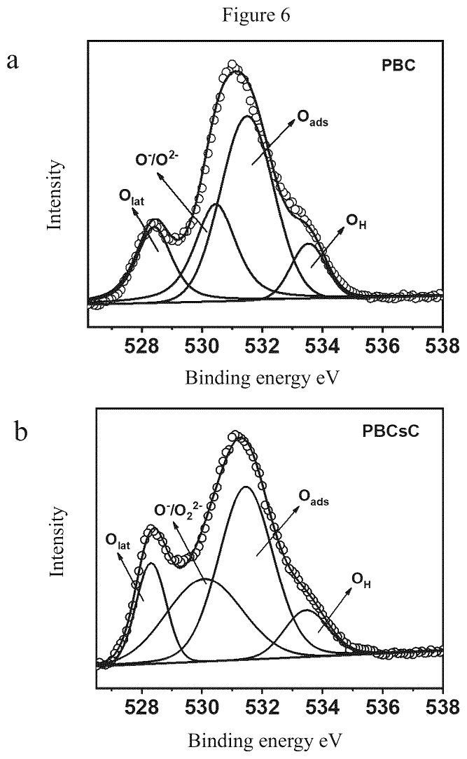

The corresponding O is XPS fitting data of PBC and PBCsC are shown in FIG. 6 (a, and b). The O1s of PBC and PBCsC can be divided into four subordinate peaks. The dependent peaks with binding energies around 528.3, 530.0, 531.4, and 533.4 eV are related to lattice oxygen (Oₗₐₜ), high oxidation oxygen (O⁻/O₂²⁻), adsorbed oxygen (O_{ads}), and oxygen (OH⁻) in the hydroxyl environment, respectively, wherein, the ratio of O⁻/O₂²⁻ and Oₗₐₜ reflects the content of oxygen vacancies, while the ratios in PBC and PBCsC are 1.49 and 2.03, respectively. In addition, the proportion of O⁻/O₂²⁻ in oxides is often considered to play a crucial role in the ORR process.

### 3. Relaxation Characterization

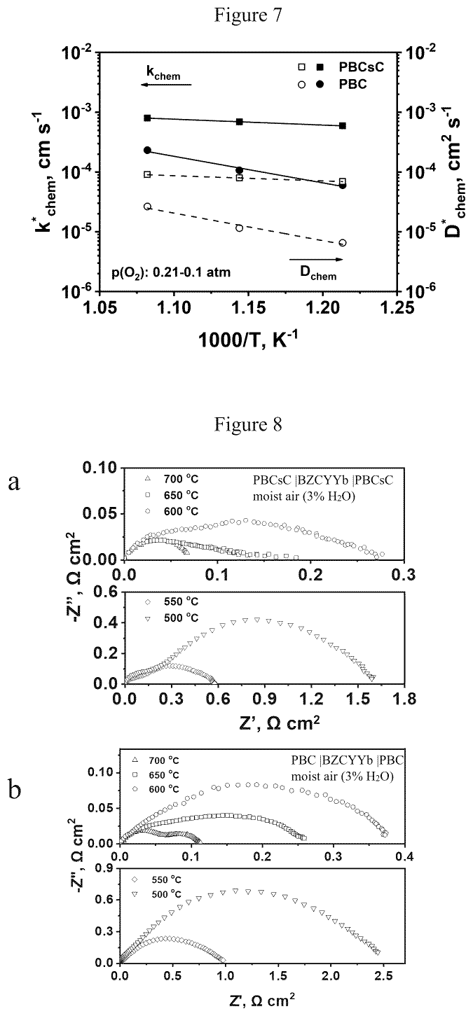

FIG. 7 shows the surface exchange coefficient k*_{chem} and bulk diffusion coefficient D*_{chem} of PBCsC and PBC tested in temperatures ranging from 550° C. to 650° C., wherein, the surface exchange coefficient of PBCsC tested at 650° C. was calculated to be 7.98×10⁻⁴ cm s⁻¹, which is higher than that of PBC tested under the same conditions (2.31×10⁻⁴ cm s⁻¹). The increase in k*_{chem} value indicates that the PBCsC air electrode has a fast oxygen surface exchange kinetics, thereby accelerating the ORR reaction process. The results of D*_{chem} also show a similar trend. Under testing condition of 650° C., the D*_{chem} values of PBC and PBCsC are 2.64×10⁻⁵ and 9.01×10⁻⁵ cm² s⁻¹, respectively. The larger the D*_{chem} value of PBCsC, the better the oxygen diffusion kinetics thereof. In summary, the enhancement of electrocatalytic activity of the PBCsC air electrode may be due to the doping of the A-site dopant (Cs), which generates more oxygen vacancies and improves surface exchange kinetics.

### 4. Research on Electrochemical Impedance and Stability

The electrocatalytic activity of the PBCsC air electrode was studied for the first time by measuring the area specific resistance of a symmetric cell supported by BZCYYb1711 in moist air (3% H₂O) at 700° C. to 500° C. As shown in FIG. 8(a), the area specific resistance values of the PBCsC air electrode at 700° C., 650° C., 600° C., 550° C., and 500° C. reach 0.067, 0.184, 0.276, 0.575, and 1.588Ω cm², respectively. FIG. 8(b) shows the electrocatalytic activity of the PBC air electrode. Under the same testing conditions, the area specific resistance values of the PBC air electrodes at 700° C., 650° C., 600° C., 550° C., and 500° C. reach 0.113, 0.258, 0.372, 0.977, and 2.443Ω cm², respectively. Compared with the PBC air electrode, the PBCsC air electrode has higher electrocatalytic activity.

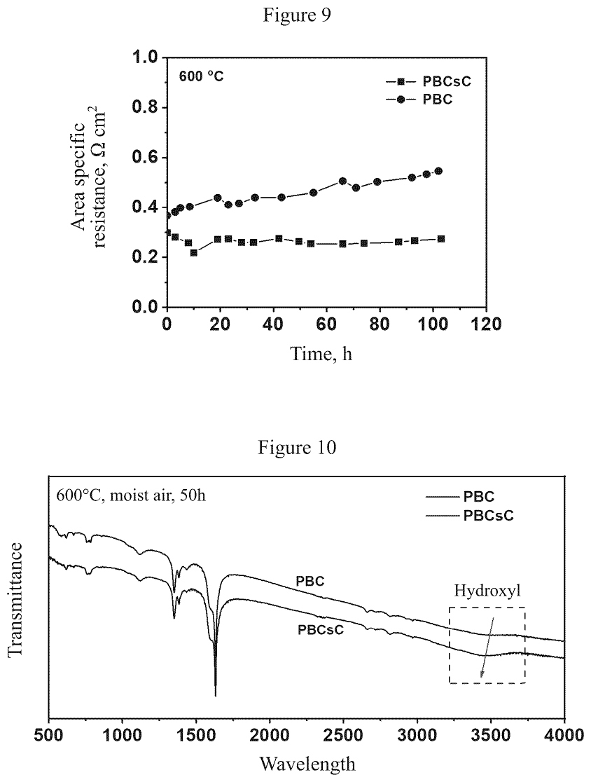

FIG. 9 shows the stability of PBCsC and PBC in moist air (3% H₂O). When exposed to moist air, the area specific resistance value of the PBC air electrode significantly increases with the extension of testing time. On the contrary, under the same testing conditions, the area specific resistance value of the PBCsC air electrode shows better stability. Based on the above analysis, a symmetric cell with the PBCsC air electrode exhibits better stability and higher electrocatalytic activity.

### 5. Characterization of Fourier Transform Infrared Spectra (FTIR)

FIG. 10 shows the Fourier transform infrared spectra of PBCsC and PBC air electrodes after 50 hours of treatment in moist air containing 30% water vapor at 600° C. FTIR measurement can identify hydroxyl signal values in oxides, with characteristic peaks appearing in the range of 3400 to 3800 cm⁻¹. The test results show that the hydroxyl peak intensity of PBCsC treated with 30% water vapor is slightly higher than that of PBC oxide, indicating that PBCsC exhibits better hydration behavior.

### 6. Electrochemical Performance Test

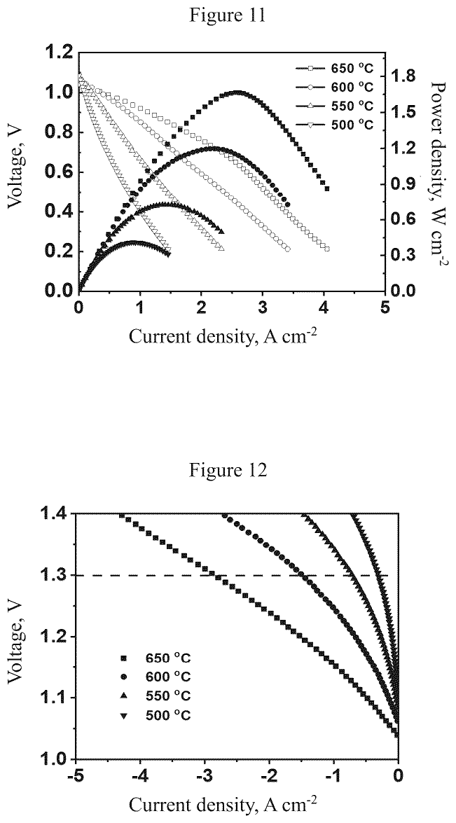

The cell prepared in Example 2 was subjected to electrochemical power density testing in fuel cell mode (FC mode) and current density testing in electrolysis mode (EC mode). FIG. 11 shows that a full cell composed of PBCsC involved in the present application as the air electrode is tested in fuel cell mode with humidified hydrogen gas introduced on the anode side and air atmosphere on the air electrode side. The power densities tested within the range of 650° C. to 500° C. are 1.66 W cm⁻², 1.19 W cm⁻², 0.72 W cm⁻², and 0.41 W cm⁻², respectively.

FIG. 12 shows the I-V curve diagram of a single cell (Ni-BZCYYb1711∥BZCYYb1711∥PBCsC) prepared with PBCsC involved in the present application as the air electrode and Ni-BZCYYb1711 as the fuel electrode support, tested in EC mode (with humidified hydrogen gas introduced on the anode side and humidified air introduced on the oxygen electrode side) within the range of 650° C. to 500° C., wherein, the electrolytic cell of the PBCsC air electrode also shows better electrolysis performance, with current densities of −2.85 A cm⁻², −1.48 A cm⁻², −0.71 A cm⁻², and −0.31 A cm⁻² under 1.3 V voltage conditions at 650° C., 600° C., 550° C., and 500° C., respectively.

### 7. Single Cell Stability and Cycle Test

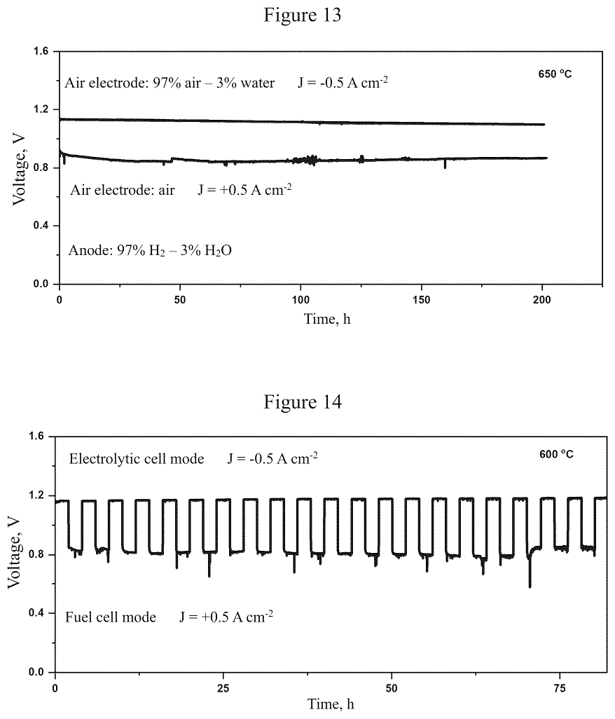

FIG. 13 shows the long-term stability of the PBCsC air electrode with a current density of 0.5 A cm⁻² at 650° C. and operating in FC mode for 170 hours. In addition, due to the presence of moist air in the R-PCEC air electrode chamber, the resistance of the air electrode to steam is crucial for the stability of the cell. The full cell with the PBCsC air electrode shows good stability in electrolysis mode using moist air (3% H₂O) as an oxidant, and runs stably for 200 hours at −0.5 A cm⁻² and 650° C. Cycling tests with FC and EC dual-mode switching every 2 hours were performed under ±0.5 A cm⁻² and at a temperature of 600° C. (FIG. 14). The cell with the PBCsC air electrode shows good stability during 80 hours of reversible operation.

### 8. Faradaic Efficiency and Hydrogen Production Rate Test

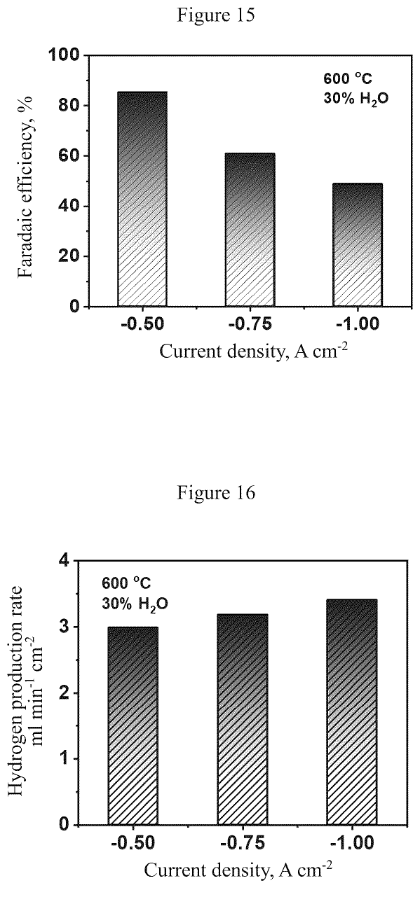

Faradaic efficiency is crucial for hydrogen production in the electrochemical process of R-PCEC, defined as the ratio of the actual H₂ production rate (detected by gas chromatography equipment) to the theoretical H₂ production rate (calculated by applied current). FIG. 15(a, and b) shows the Faradaic efficiency and hydrogen production rate under different current densities at 600° C. in moist air (steam concentration of 30%). When the cell is tested at different current densities of −0.5 A cm⁻², −0.75 A cm⁻², and −1.0 A cm⁻², the Faradaic efficiency decreases from 85.37% to 60.86% and 48.88%, as shown in FIG. 15(a). In addition, at current densities of −0.5 A cm⁻², −0.75 A cm⁻², and −1.0 A cm⁻², the corresponding H₂ generation rates increase from 2.98 to 3.18 and 3.41, as shown in FIG. 15(b).

Finally, it should be noted that the above examples are only used to illustrate the technical solution of the present application, and not to limit the technical solution of the present application. Although the present application has been described in detail with reference to the aforementioned examples, a person skilled in the art should understand that they can still modify the technical solutions recited in the aforementioned examples or equivalently replace some of the technical features thereof, and these modifications or replacements do not make the essence of the corresponding technical solutions deviate from the spirit and scope of the technical solutions of the various examples of the present application.

What is claimed is:

1. A double perovskite material, wherein the double perovskite material has an expression of PrBa₁₋ₓCsₓCo₂O_{6-δ}; wherein δ is oxygen vacancy content.

2. The double perovskite material according to claim 1, wherein x is in a range from 0.01 to 0.15, preferably x is in a range from 0.05 to 0.125.

3. The double perovskite material according to claim 1, wherein the double perovskite material has a tetragonal layered perovskite structure; preferably, the lattice parameters are as follows: 3.9045±0.1 Å for a, 3.9045±0.1 Å for b, and 7.6572±0.1 Å for c.

4. The double perovskite material according to claim 1, wherein the expression is PrBa_{0.9}Cs_{0.1}Co₂O_{6-δ}.

5. A preparation method for the double perovskite material according to claim 1, wherein the preparation method comprises the following steps:
1) dissolving praseodymium nitrate, barium nitrate, cesium nitrate, and cobalt nitrate in water to obtain a liquid; then mixing the liquid with ethylenediaminetetraacetic acid, citric acid, and ammonia water, adjusting pH to 7 to 8, and obtaining a solution; and
2) heating the solution until gelatinous, subjecting the resultant to a high temperature treatment at 200° C. to 250° C. to obtain a precursor, and calcining the precursor.

6. The preparation method for the double perovskite material according to claim 5, wherein in step 1), the molar ratio of metal elements, ethylenediaminetetraacetic acid, and citric acid is (0.5 to 1.5):(0.5 to 1.5):(1 to 2); wherein the amount for the metal elements is the sum of Pr, Ba, Cs, and Co.

7. The preparation method for the double perovskite material according to claim 5, wherein in step 2), the solution is heated at a temperature of 80° C. to 100° C.; and/or, the high-temperature treatment is performed for 2 to 6 hours; and/or, the precursor is calcined at a temperature of 950° C. to 1050° C. for 2 to 4 hours.

8. A reversible protonic ceramic electrochemical cell, wherein the reversible protonic ceramic electrochemical cell comprises an anode support layer, an electrolyte, and an air electrode connected in sequence; the air electrode is prepared from the double perovskite material according to claim 1.

9. The reversible protonic ceramic electrochemical cell according to claim 8, wherein the electrolyte material comprises BaZr_{0.1}Ce_{0.7}Y_{0.1}Yb_{0.1}O_{3-δ}, wherein δ is oxygen vacancy content; and/or,
the material of the anode support layer comprises NiO and BaZr_{0.1}Ce_{0.7}Y_{0.1}Yb_{0.1}O_{3-δ}, wherein the mass ratio of NiO and BaZr_{0.1}Ce_{0.7}Y_{0.1}Yb_{0.1}O_{3-δ} is (5.5 to 6.5):(3.5 to 4.5); and/or
the reversible protonic ceramic electrochemical cell further comprises a transition layer, wherein the transition layer is disposed between the anode support layer and the electrolyte;
preferably, the transition layer comprises NiO and BaZr_{0.1}Ce_{0.7}Y_{0.1}Yb_{0.1}O_{3-δ}; wherein the mass ratio of NiO and BaZr_{0.1}Ce_{0.7}Y_{0.1}Yb_{0.1}O_{3-δ} is (5.5 to 6.5):(3.5 to 4.5).
